(19) United States
(12) Patent Application Publication
(10) Pub. No.: US 2026/0290937 A1
(43) Pub. Date: Sep. 24, 2026

(54) BATTERY PACK

(71) Applicant: TECHTRONIC CORDLESS GP, Anderson, SC (US)

(72) Inventors: Hei Man LEE, Hong Kong (CN); Jin Hui ZHOU, Dongguan City (CN); Dian Wu XU, Dongguan City (CN); Kui ZENG, Dongguan City (CN); Pei LIAO, Dongguan City (CN)

(21) Appl. No.: 19/474,127

(22) PCT Filed: Apr. 13, 2023
(86) PCT No.: PCT/CN2023/088137

§ 371 Date: Oct. 9, 2025

(51) Int. Cl. H01M 10/6551; H01M 10/42; H01M 10/613; H01M 10/6563; H01M 50/284

(52) U.S. Cl. CPC H01M 10/6551; H01M 10/4257; H01M 10/613; H01M 10/6563; H01M 50/284

(57) ABSTRACT

A battery pack includes a housing forming a cavity and a plurality of battery cells disposed within the cavity and configured to supply power to the electrical device. The battery pack further includes a circuit board disposed within the housing including a plurality of electrical components and a heat sink partially formed within the housing and in direct contact with heat generating components of the circuit board.

### FIELD OF THE DISCLOSURE

The present disclosure relates to battery packs, and more particularly, to heat sinks used in battery packs.

### SUMMARY

Lithium-ion batteries may produce heat during charging and discharging as a result of the electrochemical reaction driving the battery and the current flowing through the electronic components. Excess heat can result in several complications, including thermal runaway. Power tool batteries may be particularly at risk of overheating due to the large currents pulled by the power tool and the compact nature of the battery electronics and terminals.

In one aspect, the application provides a battery pack for a power tool includes a housing forming a cavity and at least one terminal configured to electrically connect the battery pack to the power tool. The battery pack also includes a plurality of battery cells disposed within the cavity and configured to supply power to the power tool. The battery pack further includes a circuit board disposed within the housing including a plurality of electrical components. The battery pack further includes a heat sink partially formed within the housing and in direct contact with heat generating components of the circuit board.

In one aspect, the heat sink further includes a first plurality of fins extending in a first direction and a second plurality of fins extending in a second direction that is different than the first direction, the second plurality of fins extend away from the housing toward the circuit board and into the cavity. In one aspect, the heat sink further includes a first leg, a second leg, and a third leg, wherein the third leg includes the first plurality of fins and the second plurality of fins. In one aspect, the third leg is formed within the housing, such that a top side of the third leg is fully surrounded by the housing and a bottom side of the third leg is exposed to the cavity of the housing. In one aspect, the second leg is encased in the housing, such that the second leg is not directly exposed to the cavity or ambient air. In one aspect, the first leg and the third leg are parallel to each other, while the second leg is perpendicular to both the first leg and the third leg. In one aspect, the first direction is the same direction that the third leg extends along, whereas the second direction is obliquely angled relative to the first direction. In one aspect, the first leg is exposed to the cavity and is in contact with the heat generating components.

In one aspect, a portion of the heat sink is exposed to ambient air surrounding the battery pack. In one aspect, the portion of the heat sink is exposed in a recess formed in the housing, the recess opens into ambient air. In one aspect, the recess is sized to inhibit a user from accessing the recess.

In one aspect, the heat sink is not in contact or exposed to ambient air surrounding the battery pack. In one aspect, the housing provides an air inlet and an air outlet, allowing an airflow path to be formed through the cavity from the air inlet to the air outlet, wherein the airflow path passes over the heat sink. In one aspect a fan is provided in the housing and configured to create the airflow path.

In one aspect, the housing includes a first housing portion, and a second housing portion coupled to the first housing portion, wherein the first housing portion and the second housing portion form the cavity. In one aspect, the heat sink further includes a first leg, a second leg, and a third leg, wherein the third leg includes a first plurality of fins and a second plurality of fins extending in different directions. In one aspect, the third leg is formed within the first housing portion, such that a top side of the third leg is flush with first housing portion and exposed to ambient air, and a bottom side of the third leg is flush with the first housing portion and exposed to the cavity of the housing. In one aspect, the second leg is encased in the first housing portion, such that the second leg is not directly exposed to the cavity or ambient air. In one aspect, the first leg and the third leg are parallel to each other, while the second leg is perpendicular to both the first leg and the third leg. In one aspect, the first leg is exposed to the cavity and is in contact with the heat generating components of the circuit board Other aspects of the invention will become apparent by consideration of the detailed description and accompanying drawings.

### BRIEF DESCRIPTION OF DRAWINGS

FIG. 1 is a perspective view of a battery pack according to an embodiment of the application.

FIG. 2 is a rear perspective view of the battery pack of FIG. 1 according to some embodiments.

FIG. 3 is an exploded view of the battery pack of FIG. 1, illustrating a heat sink coupled to a first housing portion of a housing, according to some embodiments.

FIG. 4 is cross-sectional view of the battery pack along line 4-4 of FIG. 2, illustrating an airflow path within the housing, according to some embodiments.

FIG. 5 is an enlarged perspective view of the battery pack of FIG. 1, illustrating an airflow path according to another embodiment of the application.

FIG. 6 is a perspective view of the heat sink of FIG. 1, illustrating a plurality of fins, according to some embodiments.

FIG. 7 is an enlarged view of the battery pack of FIG. 4, illustrating the heat sink disposed within the housing, according to some embodiments.

FIG. 8 is an enlarged view of the battery pack of FIG. 4, illustrating a heat sink according to another embodiment of the application.

Before any embodiments are explained in detail, it is to be understood that the embodiments described herein are not limited in its application to the details of construction and the arrangement of components set forth in the following description or illustrated in the following drawings. The application is capable of other embodiments and of being practiced or of being carried out in various ways. Also, it is to be understood that the phraseology and terminology used herein is for the purpose of description and should not be regarded as limiting.

Features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the embodiments described herein.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

### DETAILED DESCRIPTION

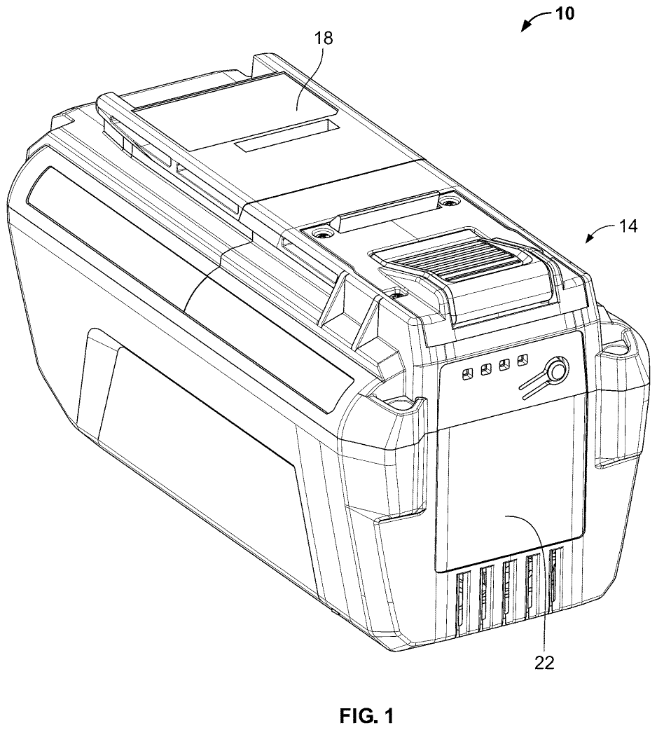

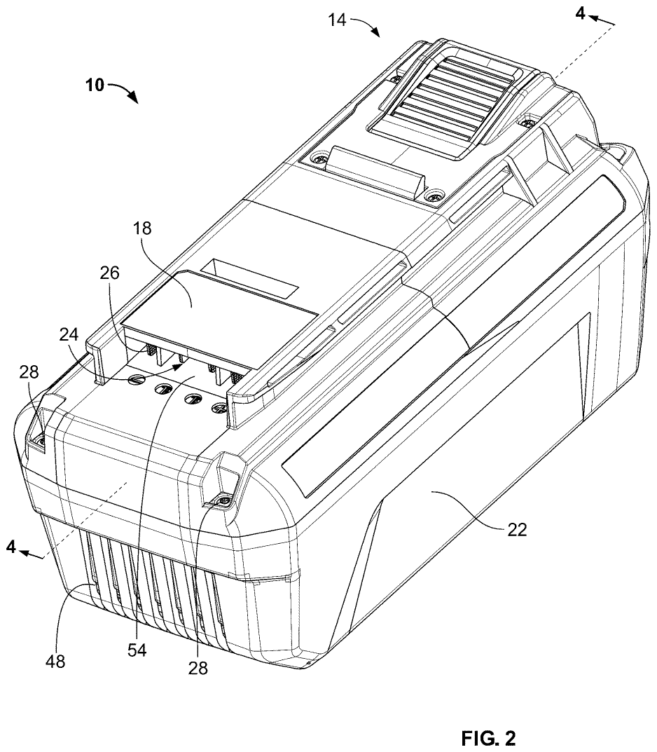

FIGS. 1 and 2 illustrate a battery pack 10 according to some embodiments. The battery pack 10 is connectable and operable to power electrical equipment, such as, hand-held power tools (e.g., drills, fasteners, saws, pipe cutters, sanders, nailers, staplers, vacuum cleaners, etc.), motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, riding lawn mower etc.), other motorized devices (e.g., vehicles, utility carts, a material handling cart, etc.), and non-motorized electrical devices (e.g., a power source, a light, an AC/DC adapter, a generator, personal electronic device, etc.), any one of which may now be referred to herein as “electrical device.” Still, in other embodiments, the battery pack 10 is connectable and operable to power other electrical devices. The battery pack 10 is removable from the electrical device and is rechargeable by a battery charger (not shown).

The battery pack 10 includes a battery chemistry such as, lead-acid, Nickel-cadmium (“NiCd”), Nickel-Metal Hydride (“NiMH”), Lithium (“Li”), Lithium-ion (“Li-ion”), other Lithium-based chemistry, or other rechargeable or non-rechargeable battery chemistry. In some embodiments, the battery pack 10 can have a battery chemistry of Li, Li-ion, or another Li-based chemistry and can supply an average discharge current that is equal to or greater than approximately 20 A. In one example, the battery pack 10 can have a chemistry of Lithium Cobalt (“Li—Co”), Lithium Manganese (“Li—Mn”) Spinel, Li—Mn Nickel, or other lithium metal chemistry.

The battery pack 10 includes a nominal voltage. In some embodiments, the battery pack 10 can have a nominal voltage of approximately 9.6 V. In other embodiments, the battery pack 10 can have a nominal voltage up to approximately 50 V. In some embodiments, the battery pack 10 can have a nominal voltage of approximately 21 V. In other embodiments, the battery pack 10 can have a nominal voltage of approximately 28 V. Still, in other embodiments, the battery pack 10 can have a nominal voltage, such as, 12 V, 14.4 V, 18 V, 24 V, 40 V, or 80 V to power the electrical device and be charged by the battery charger (not shown).

With continued reference to FIGS. 1 and 2, the battery pack 10 includes a housing 14 having a first housing portion 18 and second housing portion 22. The battery pack 10 further includes an electrical interface 24 having one or more terminals 26 that are configured to interface and electrically connect to the electrical device. The terminals 26 are accessible from outside the housing 14 to allow the electrical device to directly engage the electrical interface 24. The first housing portion 18 and the second housing portion 22 are coupled together via a plurality of fasteners 28. An O-ring (not shown) is disposed at the interface between the first housing portion 18 and the second housing portion 22 to inhibit dirt and other debris from entering the housing 14. Specifically, the O-ring is partially received within a groove 29 that extends around the periphery of the second housing portion 22 and is further received within a corresponding groove (not shown) that extends around the periphery of the first housing portion 18 when the first and second housing portions 18, 22 are coupled together. Although fasteners 28 are used to couple the first and second housing portion 18, 22 together in the illustrated embodiment, in other embodiments, the first housing portion 18 and the second housing portion 22 can be coupled together via adhesives, tapes, fasteners, tabs, or any combination thereof. The battery pack 10 further includes a locking mechanism 20 that is configured to selectively couple the battery pack 10 to the electrical device.

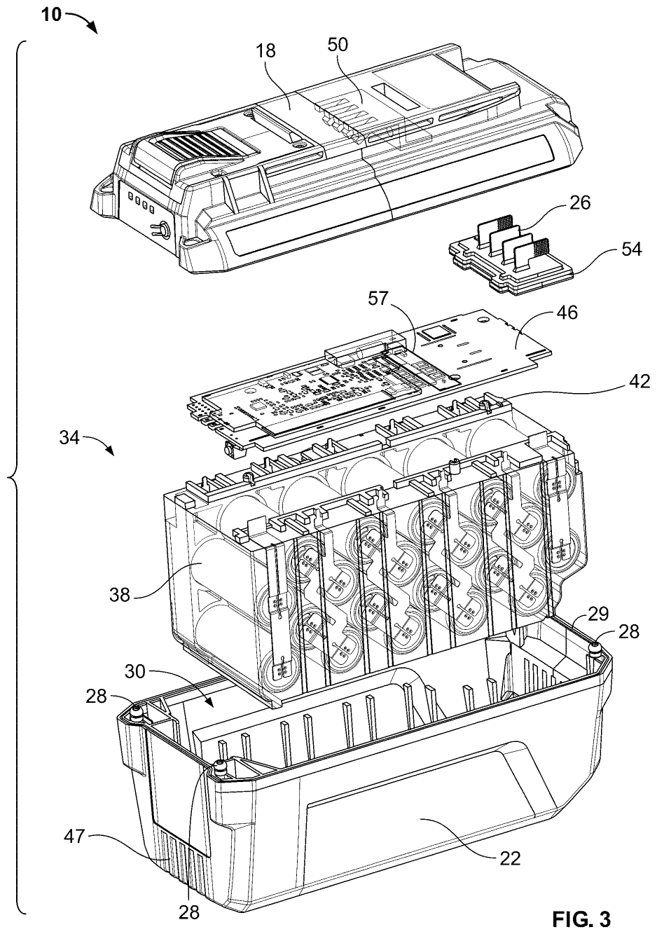

With reference to FIG. 3, the housing 14 defines an internal cavity 30. The housing 14, and more specifically, the cavity 30 receives and supports a battery cell assembly 34. The battery cell assembly 34 includes a plurality of battery cells 38 and a support structure 42 that receives and supports the plurality of battery cells 38. The plurality of battery cells 38 include a chemistry and a nominal voltage as described above. In the illustrated embodiment, the housing 14 is shaped and sized to receive twenty battery cells 38, while in other embodiments, the housing 14 may receive a different predetermined number of battery cells 38 (e.g., ten, thirty, forty, one hundred, etc.). In some embodiments, the battery cell assembly 34 can include two or more battery cells 38. The battery cells 38 can be connected in series, parallel, or combination series-parallel to provide the desired electrical characteristics (e.g., nominal voltage, current output, current capacity, power capacity, etc.) of the battery pack 10.

With continued reference to FIG. 3, the housing 14 substantially encloses a supporting circuit or circuit board 46 electrically connected to the one or more terminals 26. The circuit board 46 is disposed above and supported by the battery cell assembly 34, such that the circuit board 46 is located within the first housing portion 18 of the housing 14. In particular, the circuit board 46 is supported on top of the support structure 42 of the battery cell assembly 34 and adjacent the first housing portion 18. The circuit board 46 includes a microcontroller or microprocessor and is configured to provide operational control of the battery pack 10 and monitor various characteristics (e.g., voltage, temperature, etc.) of each individual battery cell 38. For example, the circuit board 46 controls the electrical components within the battery pack 10 in order to control the charging and discharging of the battery cells 38. Put simply, the circuit board 46 may supply power to the electrical device via the battery cells 38. That said, the circuit board 46 may communicate with the electrical device, the battery charger (not shown), and may provide information to the devices regarding one or more battery characteristics or conditions of the battery pack 10, such as, the nominal voltage, the temperature, the chemistry, and/or other similar characteristics.

With reference to FIGS. 1-4, the housing 14 also includes an air inlet 47, an air outlet 48, and a fan 49 configured to create an airflow path AF within the cavity 30 of the housing 14. In some embodiments, the battery pack 10 may include a plurality of ducts or channels disposed within the housing 14 in order to guide the airflow path AF over specific electronic components (e.g., the terminal, microprocessor, battery cells, MOSFETS, etc). The battery pack 10 may also include a plurality of fans, for example, a first fan may be used to draw ambient air in through the air inlet 47 along the airflow path AF and a second fan may be used to guide the airflow path AF towards the air outlet 48. The fan 49 may also be operatively controlled by the circuit board 46. For example, in some embodiments, the fan 49 may be used to direct the airflow path AF to a specific component or area of the circuit board 46 and battery cell assembly 34 based on signals received by the circuit board 46.

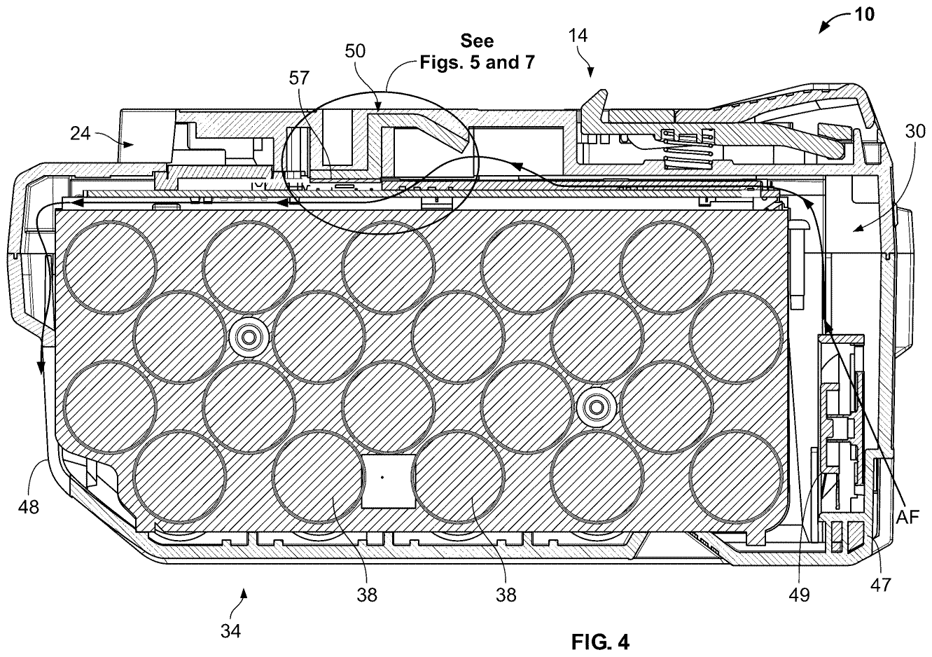

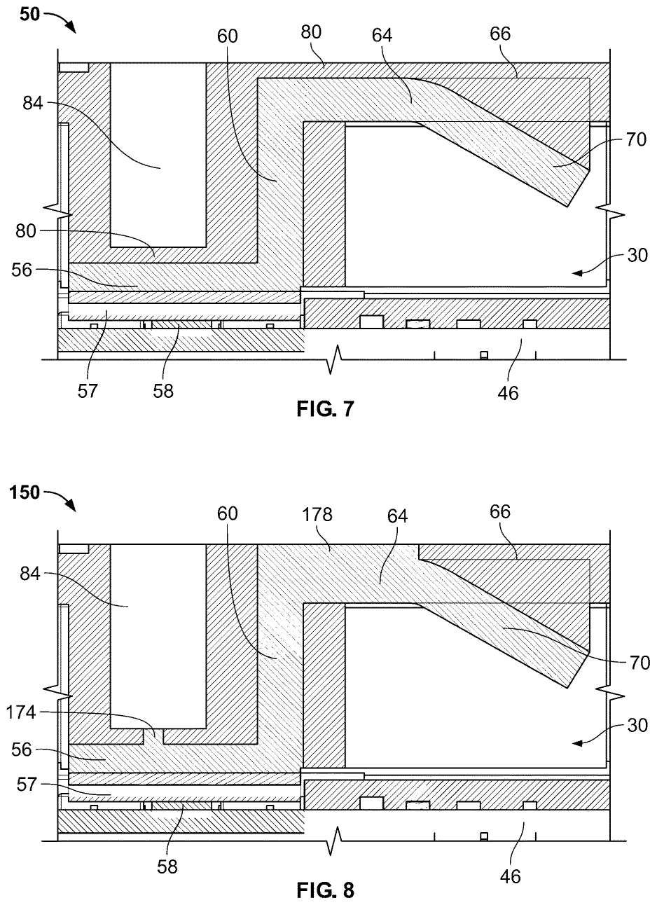

With reference to FIGS. 3 and 4, the battery pack 10 may further include a heat sink 50 and a terminal contact plate 54 that is adjacent the heat sink 50. The terminal contact plate 54 supports the terminals 26 and places the terminals 26 in electrical connection with the circuit board 46. That is, the terminal contact plate 54 is in direct contact (or thermal contact) with the circuit board 46 and is adjacent the heat sink 50. The heat sink 50 is also in direct contact (or thermal contact) with heat generating components (e.g., a plurality of MOSFETs 58, resistors, transistors, capacitors, inductors, sensors, etc.) of the circuit board 46. A plate 57 (FIGS. 3 and 7) may be coupled between the plurality of MOSFETs 58 and the heat sink 50, allowing for thermal conduction between the MOSFETs 58 and the heat sink 50 without creating an electrical connection. Accordingly, in some embodiments, the plate 57 is composed of a thermally conductive and electrically insulative material (e.g., aluminum nitride, carbon fiber composites, diamond like carbon, etc.). In some embodiments, the plate 57 may be composed of an electrically conductive material and contact the MOSFETs 58 without causing a short circuit.

With continued reference to FIGS. 3 and 4, the heat sink 50 may extend over some of the electrical components of the circuit board 46, allowing the heat sink 50 to capture heat that is expelled from the circuit board 46 and dissipate the heat away from the circuit board 46 to avoid inadvertent damage from overheating. The heat sink 50 may be composed of various thermally conductive materials (e.g., aluminum, copper, metallic alloys, composite alloys, etc.).

With reference to FIGS. 3-5, the heat sink 50 is disposed within the housing 14, and more specifically, may be molded within the first housing portion 18 directly adjacent the circuit board 46. The heat sink 50 may be formed as a monolithic component having a first leg 56, a second leg 60, and a third leg 64. In other embodiments, the heat sink 50 may be formed as multiple pieces. The first leg 56 is in contact with the circuit board 46 via the plate 57, while the third leg 64 is at least partially formed within the first housing portion 18 and disposed above the circuit board 46. The second leg 60 is between the first leg 56 and the third leg 64. Also, the second leg 60 is fully disposed within and encased by the first housing portion 18. The first leg 56 and the third leg 64 are parallel to each other, and the second leg 60 is perpendicular to both the first leg 56 and the third leg 64. Although the heat sink 50 of the illustrated embodiment is molded (via an overmolding process) into the first housing portion 18, the heat sink 50 may alternatively be coupled to the first housing portion 18 using other fastening methods (e.g., screw fasteners, adhesives, magnets, etc.).

With reference to FIGS. 4-6, the third leg 64 of the heat sink 50 includes a first plurality of fins 66 extending along a first direction and a second plurality of fins 70 extending along a second direction that is different from the first direction. The first direction is along the same direction that the third leg 64 extends, whereas the second direction is bent downwards towards the circuit board 46. That is, the first plurality of fins 66 are at least partially formed within the first housing portion 18 and the second plurality of fins 70 are disposed outside of the first housing portion 18. Specifically, a top side of the first plurality of fins 66 is disposed within the first housing portion 18 of the housing, while a bottom side of the first plurality of fins 66 is flush with the first potion 18 and exposed to the cavity 30. Furthermore, the second plurality of fins 70 extend out of the first housing portion 18 and are disposed within the cavity 30 of the housing 14. The second plurality of fins 70 are located closer to the circuit board 46 than the first plurality of fins 66. In other embodiments, the heat sink 50 may also include other fins extending outwardly away from the cavity 30 to the exterior of the battery pack 10. Still, in other embodiments, each of the legs 56, 60, 64 may include additional fins extending outwardly.

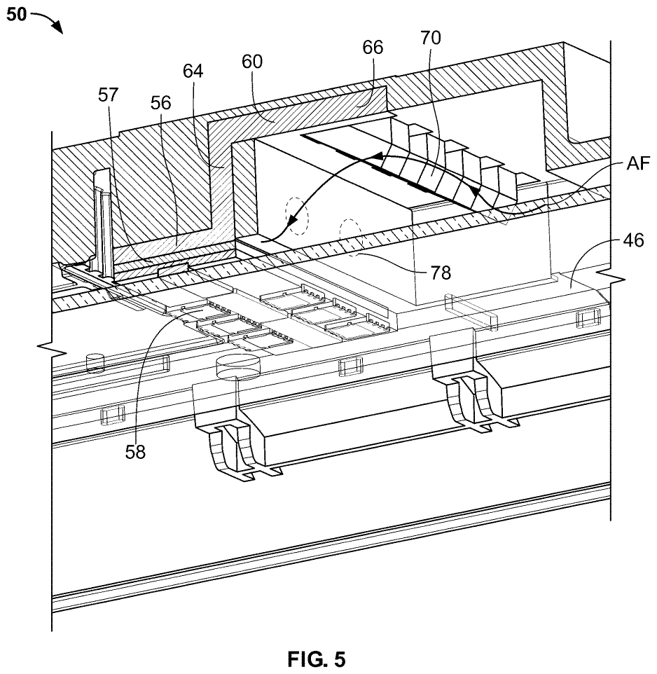

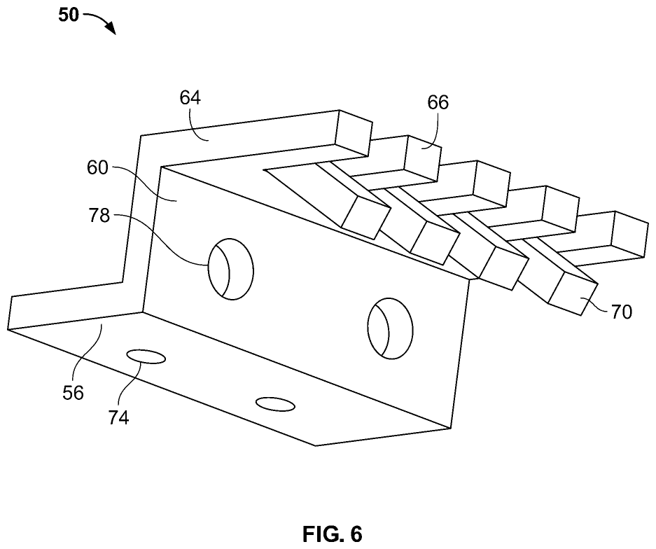

With continued reference to FIGS. 4-6, the airflow path AF passes over the circuit board and over the first and second plurality of fins 66, 70 (FIG. 4). The airflow path AF provides heat dissipation of the circuit board 46 and the heat sink 50 through convection of the first and second plurality of fins 66, 70. As shown in FIG. 6, the first leg 56 includes apertures 74 and the second leg 60 includes apertures 78. The apertures 74, 78 facilitate mounting the heat sink 50 to the circuit board 46 and the first housing portion 18. In other embodiments, the apertures 74, 78 may enable the airflow path AF to travel through the apertures 74, 78, thereby providing additional heat collection and dissipation. Still, in other embodiments, the apertures 74, 78 may serve as additional inlets and outlets to allow the airflow path AF to travel from within the housing 14 to ambient air outside the housing 14 (FIG. 5).

With reference to FIG. 7, the first housing portion 18 of housing 14 includes a recess 84 that is disposed adjacent the heat sink 50. Particularly, the recess 84 extends along the first leg 56 and the second leg 60 of the heat sink 50, allowing for the first leg 56 and the second leg 60 to dissipate heat to ambient air through the first housing portion 18 efficiently via the recess 84. Basically, only a thin portion 80 of the first housing portion 18 may separate the heat sink 50 from ambient air. The thin portion 80 may be thinner than the remainder of the thickness of the first housing portion 18. In some embodiments, the thin portion 80 may be composed of a thermally conductive material to facilitate with heat transfer between the heat sink 50 and ambient air exterior to the battery pack 10. In some embodiments, a portion of the heat sink is exposed in the recess 84, the recess opens into ambient air. The recess can be sized to inhibit a user from accessing the recess using his/her fingers. In some embodiments, the thin portion 80 can be omitted so that the heat sink is exposed.

FIG. 8 illustrates a heat sink 150 that is similar to the heat sink 50. However, the heat sink 150 is at least partially exposed to ambient air that is exterior to the battery pack 10. As shown, the heat sink 150 includes a first bridge fin 174 and a second bridge fin 178 that both extend from the heat sink 150 to ambient air that is exterior to the housing 14.

Specifically, the first bridge fin 174 extends from the heat sink 150 to the recess 84, such that the first bridge fin 174 is at least partially flush with the exterior of the first housing portion 18 and is in direct contact with ambient air. Similarly, the second bridge fin 178 extends from the heat sink 150 through the first housing portion 18, such that the second bridge fin 174 is at least partially flush with the exterior of the first housing portion 18 and is in direct contact with ambient air.

Although aspects of the present disclosure have been described in detail with reference to certain embodiments, variations and modifications exist within the scope and spirit of one or more independent aspects as described. Various features of the disclosure are set forth in the following claims.

What is claimed is:

1. A battery pack for a power tool, the battery pack comprising:
a housing forming a cavity;
at least one terminal configured to electrically connect the battery pack to the power tool;
a plurality of battery cells disposed within the cavity and configured to supply power to the power tool;
a circuit board disposed within the housing atop the plurality of battery cells and including a plurality of electrical components; and
a heat sink at least partially formed within the housing and in direct contact with heat generating components of the circuit board.

2. The battery pack of claim 1, wherein the heat sink further includes a first plurality of fins extending in a first direction and a second plurality of fins extending in a second direction that is different than the first direction, the second plurality of fins extend away from the housing toward the circuit board and into the cavity.

3. The battery pack of claim 2, wherein the heat sink further includes a first leg, a second leg, and a third leg, wherein the third leg includes the first plurality of fins and the second plurality of fins.

4. The battery pack of claim 3, wherein the third leg is formed within the housing, such that a top side of the third leg is fully surrounded by the housing and a bottom side of the third leg is exposed to the cavity of the housing.

5. The battery pack of claim 3, wherein the second leg is encased in the housing, such that the second leg is not directly exposed to the cavity or ambient air.

6. The battery pack of claim 3, wherein the first leg and the third leg are parallel to each other, while the second leg is perpendicular to both the first leg and the third leg.

7. The battery pack of claim 3, wherein the first direction is the same direction that the third leg extends along, whereas the second direction is obliquely angled relative to the first direction.

8. The battery pack of claim 3, wherein the first leg is exposed to the cavity and is in contact with the heat generating components.

9. The battery pack of claim 1, wherein a portion of the heat sink is exposed to ambient air surrounding the battery pack.

10. The battery pack of claim 9, wherein the portion of the heat sink is exposed in a recess formed in the housing, the recess opens into ambient air.

11. The battery pack of claim 10, wherein the recess is sized to inhibit a user from accessing the recess.

12. The battery pack of claim 1, wherein the heat sink is not in contact or exposed to ambient air surrounding the battery pack.

13. The battery pack of claim 1, wherein the housing provides an air inlet and an air outlet, allowing an airflow path to be formed through the cavity from the air inlet to the air outlet, wherein the airflow path passes over the heat sink.

14. The battery pack of claim 13, wherein a fan is provided in the housing and configured to create the airflow path.

15. The battery pack of claim 1, wherein the housing includes a first housing portion, and a second housing portion coupled to the first housing portion, wherein the first housing portion and the second housing portion form the cavity.

16. The battery pack of claim 15, wherein the heat sink further includes a first leg, a second leg, and a third leg, wherein the third leg includes a first plurality of fins and a second plurality of fins extending in different directions.

17. The battery pack of claim 16, wherein the third leg is formed within the first housing portion, such that a top side of the third leg is flush with first housing portion and exposed to ambient air, and a bottom side of the third leg is flush with the first housing portion and exposed to the cavity of the housing.

18. The battery pack of claim 16, wherein the second leg is encased in the first housing portion, such that the second leg is not directly exposed to the cavity or ambient air.

19. The battery pack of claim 16, wherein the first leg and the third leg are parallel to each other, while the second leg is perpendicular to both the first leg and the third leg.

20. The battery pack of claim 16, wherein the first leg is exposed to the cavity and is in contact with the heat generating components of the circuit board.
